(19) United States
(12) Patent Application Publication
(10) Pub. No.: US 2013/0168052 A1
(43) Pub. Date: Jul. 4, 2013

(54) HEAT PIPE AND COMPOSITION OF CAPILLARY WICK THEREOF

(71) Applicants: George Anthony Meyer, IV, Morgan Hill, CA (US); Chien-Hung Sun, Zhongli City (TW); Chieh-Ping Chen, Zhongli City (TW); Ming-Kuei Hsieh, Zhongli City (TW)

(72) Inventors: George Anthony Meyer, IV, Morgan Hill, CA (US); Chien-Hung Sun, Zhongli City (TW); Chieh-Ping Chen, Zhongli City (TW); Ming-Kuei Hsieh, Zhongli City (TW)

(73) Assignee: CELSIA TECHNOLOGIES TAIWAN, INC.

(21) Appl. No.: 13/341,377

(22) Filed: Dec. 30, 2011

(51) Int. Cl. F28D 15/04; B32B 5/16

(52) U.S. Cl. 165/104.26; 428/402; 428/546

(57) ABSTRACT

The present invention provides a heat pipe and a composition of a capillary wick thereof. The heat pipe includes a main body, a capillary wick and a working fluid. The main body has an inner wall surface. The capillary wick is combined on the inner wall surface. The capillary wick includes a first capillary powder of 30 weight percent and a second capillary powder of 70 weight percent. The size of particles of the first capillary powder is smaller than that of the second capillary powder. The working fluid is filled in the main body of the heat pipe. The first capillary powder and the second capillary powder are mixed to each other uniformly to be sintered on the inner wall surface of the heat pipe. By this arrangement, the heat pipe can achieve the maximum performance to remove the heat generated by an electronic element rapidly.

### BACKGROUND OF THE INVENTION

1. Field of the Invention

The present invention relates to a heat pipe, and in particular to a composition of a capillary wick of a heat pipe.

2. Description of Prior Art

A heat pipe is constituted of a copper pipe, a capillary wick and a working fluid sealed in the copper pipe. In use, an evaporating end of the heat pipe is brought into thermal contact with a surface of a heat-generating element. When a portion of the working fluid near the evaporating end absorbs the heat of the heat-generating element, it evaporates to become vapors, so that the vapor pressure is increased at the evaporating end. The vapor-phase portion of the working fluid flows from the evaporating end toward a condensing end located opposite to the evaporating end and having a lower pressure, so that a vapor flow is formed in the heat pipe. On the other end, when the vapor-phase portion of the working fluid releases its latent heat, it condenses to become liquid again. Then, the condensed portion of the working fluid flows back to the evaporating end via the capillary wick. With the phase change and the circulation of the working fluid in the heat pipe, the heat generated by the heat-generating element can be removed rapidly.

As modern electronic devices are required to be compact for easy carry, the heat pipe installed in the modern electronic device is also required to be compact with a light weight. Thus, it is an important issue for the present Inventor to achieve the maximum performance of such a compact heat pipe.

Since the performance of the heat pipe depends on the difference in the capillary pressure and the reflow resistance in the heat pipe, these two factors are dependent on the size of pores of the capillary wick. When the pores are smaller, the difference in the capillary pressure is larger, forcing the condensed working fluid to flow into the capillary wick and then to flow back to the evaporating end. On the contrary, when the pores of the capillary wick are smaller, the frictional force and the viscous force of the working fluid are increased, so that the reflow resistance of the working fluid is increased. As a result, the working fluid flows back to the evaporating end at a smaller rate, which makes the evaporating end to dry out. Similarly, when the pores of the capillary wick are larger, the working fluid is subjected to a smaller reflow resistance, which means that the difference in the capillary pressure for drawing the condensed working liquid into the capillary wick is reduced. As a result, the amount of the working fluid reflowing into the evaporating end is reduced, which also makes the evaporating end of the heat pipe to dry out.

In order to solve the above problems, the present Inventor proposes a reasonable and novel structure based on his expert knowledge and deliberate researches.

### SUMMARY OF THE INVENTION

The present invention is to provide a composition of a capillary wick of a heat pipe, whereby the maximum performance of the heat pipe can be achieved to remove the heat generated by a heat-generating element rapidly.

The present invention is to provide a composition of a capillary wick of a heat pipe, which includes a first capillary powder and a second capillary powder. The size of particles of the first capillary powder is lower than 100 meshes, and the first capillary powder is in 30 weight percent of the whole capillary wick approximately. The size of particles of the second capillary powder is in a range of 80 and 100 meshes, and the second capillary powder is in 70 weight percent of the whole capillary wick approximately. The first capillary powder and the second capillary powder are mixed to each other uniformly to be sintered on an inner wall surface of the heat pipe.

The present invention provides a composition of a capillary wick of a heat pipe, which comprises a first capillary powder of 30 weight percent and a second capillary powder of 70 weight percent. The size of particles of the first capillary powder is smaller than that of the second capillary powder. The first capillary powder and the second capillary powder are mixed to each other uniformly to be sintered on an inner wall surface of the heat pipe.

The present invention provides a heat pipe, which includes a main body, a capillary wick and a working fluid. The main body has an inner wall surface. The capillary wick is combined on the inner wall surface. The capillary wick comprises a first capillary powder of 30 weight percent and a second capillary powder of 70 weight percent. The size of particles of the first capillary powder is smaller than that of the second capillary powder. The first capillary powder and the second capillary powder are mixed to each other uniformly to be sintered on the inner wall surface of the heat pipe. The working fluid is filled in the main body of the heat pipe and permeates into the capillary wick.

The present invention provides a composition of a capillary wick of a heat pipe, wherein a first capillary powder is in about 30 weight percent of the whole capillary wick and a second capillary powder is in about 70 weight percent of the whole capillary wick. By this ratio, the heat pipe can achieve a maximum performance in operation and efficiency in cost.

In comparison with prior art, the capillary wick of the present invention comprises a first capillary powder (fine powder) and a second capillary powder (rough powder). The first capillary powder of 30 weight percent and the second capillary powder of 70 weight percent are mixed to each other uniformly. By this ratio, pores of suitable size can be formed between the first capillary powder and the second capillary powder. Thus, the difference in capillary pressure and the reflow resistance in the heat pipe can be well balanced, so that the working fluid and thus the heat pipe can achieve a best performance. However, it should be noted that, the performance of the heat pipe is not always proportional to the weight percent of the second capillary powder. When the amount of the second capillary powder is larger than 70 weight percent, the increase in the ratio of the second capillary powder cannot increase the performance of the heat pipe, but adversely increases the cost of the heat pipe. In view of this, the composition of the capillary wick of the heat pipe of the present invention makes the heat pipe to achieve a best performance with the most economical cost.

### BRIEF DESCRIPTION OF DRAWING

FIG. 1 is a cross-sectional view showing the heat pipe of the present invention;

FIG. 2 is an enlarged view showing the capillary wick of the present invention; and

FIG. 3 is a view showing the result of the heat pipe of the present invention in comparison with other heat pipes.

### DETAILED DESCRIPTION OF THE INVENTION

The detailed description and technical contents of the present invention will become apparent with the following detailed description accompanied with related drawings. It is noteworthy to point out that the drawings is provided for the illustration purpose only, but not intended for limiting the scope of the present invention.

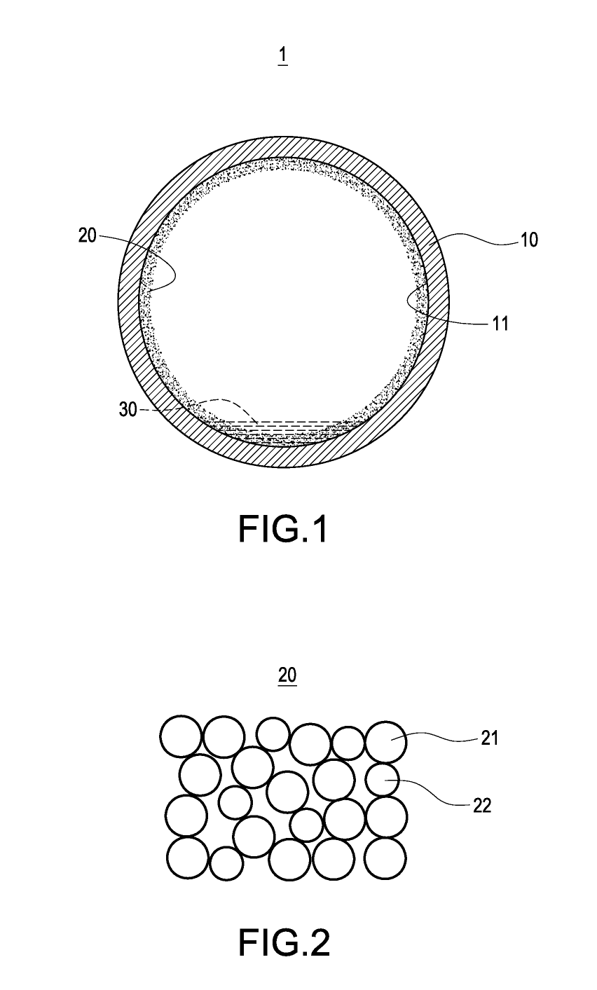

Please refer to FIGS. 1 and 2. FIG. 1 is a cross-sectional view showing the heat pipe of the present invention, and FIG. 2 is an enlarged view showing the capillary wick of the present invention. The heat pipe 1 of the present invention includes a main body 10, a capillary wick 20, and a working fluid 30. The capillary wick 20 is combined on an inner wall surface 11 of the main body 10. The working fluid 30 is filled in the main body 10 of the heat pipe 1.

The main body 10 is made of metallic materials having good heat conductivity, such as aluminum, copper or the like. The inner wall surface 11 of the main body 10 is provided with the capillary wick 20. The working fluid 30 is filled into the main body 10 and permeates into the capillary wick 20.

In the present embodiment, the unit for measuring the size of particles of the capillary wick 20 passing through a sieve or screen is a “mesh” (also referred to “sieve mesh” or “screen mesh”), which means the number of mesh pores per unit area of a sieve or screen. The smaller the “mesh” value of the capillary wick is, the larger the size of particles of the capillary wick is.

The capillary wick 20 comprises a first capillary powder 21 and a second capillary powder 22. The size of particles of the first capillary powder 21 is smaller than that of the second capillary powder 22. The first capillary powder 21 and the second capillary powder 22 are mixed to each other uniformly to be sintered on the inner wall surface 11 of the main body 10. Preferably, the capillary wick 20 comprises the first capillary powder 21 of 30 weight percent and the second capillary powder 22 of 70 weight percent.

The composition of the capillary wick 20 of the present invention will be described in more detail. The size of particles of the first capillary powder 21 is smaller than 100 meshes (fine powder). Further, the first capillary powder 21 is in 30 weight percent of the whole capillary wick 20 approximately. The size of particles of the second capillary powder 22 is in a range between 80 and 100 meshes (rough powder). Further, the second capillary powder 22 is in 70 weight percent of the whole capillary wick 20 approximately.

The first capillary powder 21 and the second capillary powder 22 are made of the same material. In the present embodiment, both the first capillary powder 21 and the second capillary powder 22 are made of copper powder.

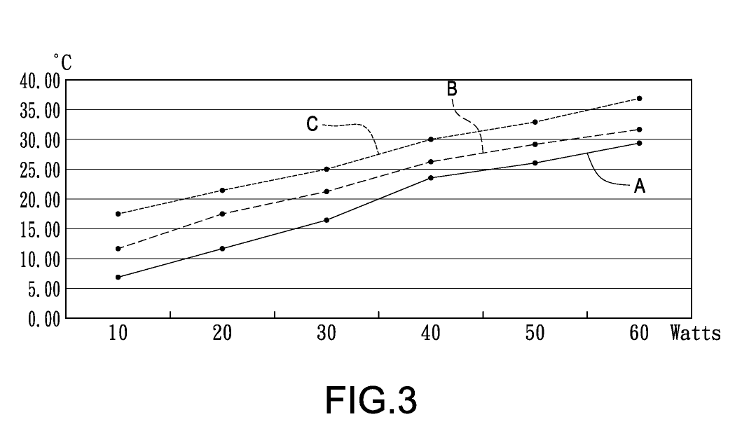

Please refer to FIG. 3, which is a view showing the result of the heat pipe of the present invention in comparison with other heat pipes. In FIG. 3, the line A, the line B and the line C respectively represent the temperature of the heat pipe A, the heat pipe B and the heat pipe C measured after the heat dissipation of lamps of different watts. The heat pipes A, B and C are made by the first capillary powder 21 and the second capillary powder 22 with different weight percents. More specifically, the heat pipe A comprises the first capillary powder 21 of 30 weight percent and the second capillary powder 22 of 70 weight percent. The heat pipe B comprises the first capillary powder 21 of 45 weight percent and the second capillary powder 22 of 55 weight percent. The heat pipe C comprises the first capillary powder 21 of 55 weight percent and the second capillary powder 22 of 45 weight percent.

As shown in FIG. 3, the line A indicates that the lamps with different watts each has a lower temperature, which means that the heat pipe A of the present invention has a better heat-dissipating efficiency. That is to say, the composition of the capillary wick 20 of the heat pipe A can achieve the maximum performance.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A composition of a capillary wick of a heat pipe, including:
a first capillary powder, the size of particles of the first capillary powder being smaller than 100 meshes, the first capillary powder being in 30 weight percent of the whole capillary wick; and
a second capillary powder, the size of particles of the second capillary powder being in a range of 80 and 100 meshes, the second capillary powder being in 70 weight percent of the whole capillary wick;
wherein the first capillary powder and the second capillary powder are mixed to each other uniformly to be sintered on an inner wall surface of the heat pipe.

2. The composition of a capillary wick of a heat pipe according to claim 1, wherein the first capillary powder and the second capillary powder are made of the same material.

3. The composition of a capillary wick of a heat pipe according to claim 2, wherein both the first capillary powder and the second capillary powder are made of copper powder.

4. A composition of a capillary wick of a heat pipe, comprising a first capillary powder of 30 weight percent and a second capillary powder of 70 weight percent, the size of particles of the first capillary powder being smaller than that of the second capillary powder, the first capillary powder and the second capillary powder being mixed to each other uniformly to be sintered on an inner wall surface of the heat pipe.

5. The composition of a capillary wick of a heat pipe according to claim 4, wherein the size of particles of the first capillary powder is smaller than 100 meshes, and the size of particles of the second capillary powder is in a range between 80 and 100 meshes.

6. The composition of a capillary wick of a heat pipe according to claim 5, wherein the first capillary powder and the second capillary powder are made of the same material.

7. The composition of a capillary wick of a heat pipe according to claim 6, wherein both the first capillary powder and the second capillary powder are made of copper powder.

8. A heat pipe, including:
a main body having an inner wall surface;
a capillary wick combined on the inner wall surface, the capillary wick comprising a first capillary powder of 30 weight percent and a second capillary powder of 70 weight percent, the size of particles the first capillary powder being smaller than that of the second capillary powder, the first capillary powder and the second capillary powder being mixed to each other uniformly to be sintered on the inner wall surface of the heat pipe; and
a working fluid filled in the main body and permeating into the capillary wick.

9. The heat pipe according to claim 8, wherein the size of particles of the first capillary powder is smaller than 100 meshes, and the size of particles of the second capillary powder is in a range between 80 and 100 meshes.

10. The heat pipe according to claim 8, wherein the first capillary powder and the second capillary powder are made of the same material.

11. The heat pipe according to claim 10, wherein both the first capillary powder and the second capillary powder are made of copper powder.
